(19) United States
(12) Patent Application Publication
(10) Pub. No.: US 2012/0224208 A1
(43) Pub. Date: Sep. 6, 2012

(54) IMAGE PROCESSING APPARATUS, IMAGE PROCESSING METHOD, AND STORAGE MEDIUM

(75) Inventor: Hirokazu Tokumoto, Kawasaki-shi (JP)

(73) Assignee: CANON KABUSHIKI KAISHA, Tokyo (JP)

(21) Appl. No.: 13/410,057

(22) Filed: Mar. 1, 2012

(30) Foreign Application Priority Data
Mar. 4, 2011 (JP) 2011-047849

(51) Int. Cl. G06F 3/12; G06K 15/02

(52) U.S. Cl. 358/1.13

(57) ABSTRACT

An image processing apparatus that performs a drawing process with respect to resource information detected from predetermined PDL data includes a PDL interpreter unit for interpreting the resource information and changing a cache process with respect to the resource information corresponding to a characteristic of the resource information interpreted thereby.

### BACKGROUND OF THE INVENTION

1. Field of the Invention

The present invention relates to an image processing apparatus and an image processing method for performing an image process by analyzing print information, and relates to a storage medium.

2. Description of the Related Art

Image processing apparatuses handle various electronic formats, and one example of an electronic format is an Extensible Markup Language (XML) paper specification (XPS) which has recently been proposed by Microsoft® Corporation. The XPS has three hierarchical levels: FixedDocumentSequence; FixedDocument; and FixedPage. Each of the hierarchical levels is provided with drawing information called ResourceDictionary (hereinafter referred to as RD) to serve as a resource, so that information relating to the drawing can be repeatedly referred.

When a drawing command such as an RD is once cached and is repeatedly referred to, a storage for mat to be cached is important as a printing speed and a data size. For example, Japanese Patent Application Laid-Open No. 2006-150944 discusses a unit configured to switch between a process in which image data to be cached is edged and stored and a process in which image data to be cached is simply compressed and stored. Such a unit, as a conventional technique, switches the processes depending on conditions to achieve a suitable print speed.

The RD in the XPS has specifications in which a referable resource area is designated and a scope that exceeds a page (FixedPage) cannot be defined. Moreover, if an RD is cached across pages for performance enhancement, the RD is influenced by an exception page print setting in an XPS PrintTicket. In addition, an RD in the XPS provides diversified specifications in which a variety of data formats can be defined as resources, unlike conventional cache data.

According to the conventional technique, therefore, it is only determined whether the data to be cached is stored with or without edging. However, such a decision to only edge or not to edge leads to low cache efficiency concerning some data, causing difficulty in achieving an adequate performance speed.

### SUMMARY OF THE INVENTION

One aspect of the present invention is directed to a configuration capable of changing a cache process corresponding to a characteristic of resource information when page description language (PDL) data is interpreted and then drawing information specified by resource information is cached.

According to an aspect of the present invention, an image processing apparatus, which performs a drawing process with respect to resource information detected from predetermined PDL data, includes a memory, and a control device connected to the memory, wherein the control device is configured to control at least one interpretation unit configured to interpret the resource information, and a control unit configured to change a cache process with respect to the resource information corresponding to a characteristic of the resource information interpreted by the at least one interpretation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of an image processing system employing an image processing apparatus.

FIG. 2 is a diagram illustrating a software module of a control device of the image processing apparatus.

FIG. 3 is a diagram illustrating a data structure of an XPS document that can be processed by the image processing apparatus.

FIGS. 4A, 4B, 4C and 4D are diagrams illustrating entry examples of RD.

FIG. 5 is a flowchart illustrating a data processing method of the image processing apparatus.

FIGS. 6A, 6B, 6C and 6D are schematic diagrams illustrating cache formats and characteristics thereof in the image processing apparatus.

FIG. 7 is a flowchart illustrating a data processing method of the image processing apparatus.

FIGS. 8A and 8B are schematic diagrams illustrating a change in a cache area in the image processing apparatus.

FIGS. 9A and 9B are diagrams illustrating performance efficiency of the image processing apparatus.

FIG. 10 is a flowchart illustrating a data processing method of the image processing apparatus.

### DESCRIPTION OF THE EMBODIMENTS

Various exemplary embodiments, features, and aspects of the invention will be described in detail below with reference to the drawings.

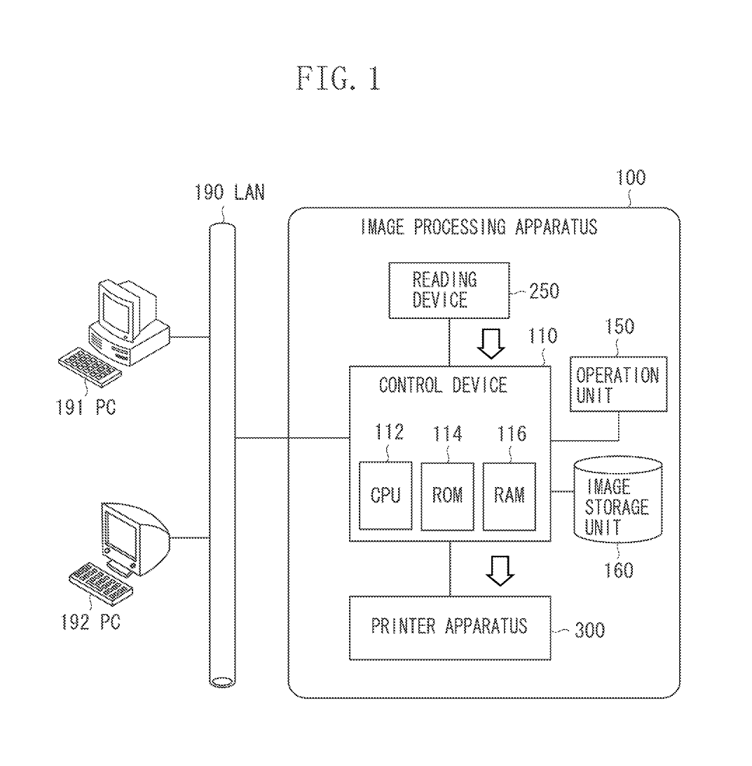

FIG. 1 illustrates an example of an image processing system employing an image processing apparatus according to a first exemplary embodiment. In the example of the image processing system, an image forming apparatus 100 serving as the image processing apparatus can communicate with a plurality of data processing devices (e.g., personal computers) through a local area network (LAN) 190. In the first exemplary embodiment, the image forming apparatus 100 is, as an example, a multi-function printer (MFP). Alternatively, a single function printer (SFP) or a laser beam printer (LBP) may serve as the image processing apparatus. In addition to these printers, the exemplary embodiment of the present invention can be applied to a printer employing other printing systems. According to the exemplary embodiment, the image processing apparatus processes drawing information in an XPS format as a predetermined electronic format, as an example.

In FIG. 1, the image forming apparatus 100 is connected to a host computer 191 serving as a first data processing apparatus (e.g., personal computer (PC)) and a second data processing apparatus (e.g., PC) 192 through the LAN 190.

The image forming apparatus 100 includes a reading device 250, a printer apparatus 300, an operation unit 150, an image storage unit 160, and a control device 110 which controls each of these components.

The image forming apparatus 100 includes a read only memory (ROM) 114, a random access memory (RAM) 116, a central processing unit (CPU) 112. The CPU 112 integrally controls the entire image forming apparatus 100 based on a program stored in the ROM 114 or other storage media. The RAM 116 is used as a work area of the CPU 112. The reading device 250 reads image data. The printer apparatus 300 outputs image data using a printer engine. The operation unit 150 includes a keyboard for input and output operation of image data, and a liquid crystal panel used to display/set image data and various functions thereon. The image storage unit 160 can store/save data such as electronic documents and image data therein.

The host computer 191 transmits an electronic document to the image forming apparatus 100 through the LAN 190. The image forming apparatus 100 uses the CPU 112 of the control device 110 to interpret the received electronic document and generate output image data to output the data to a print medium, such as a sheet, by the printer apparatus 300. Herein, the electronic document is input through the LAN 190. Alternatively, an electronic document stored in the image storage unit 160 or a portable media such as a universal serial bus memory connected to the image forming apparatus 100 may be used.

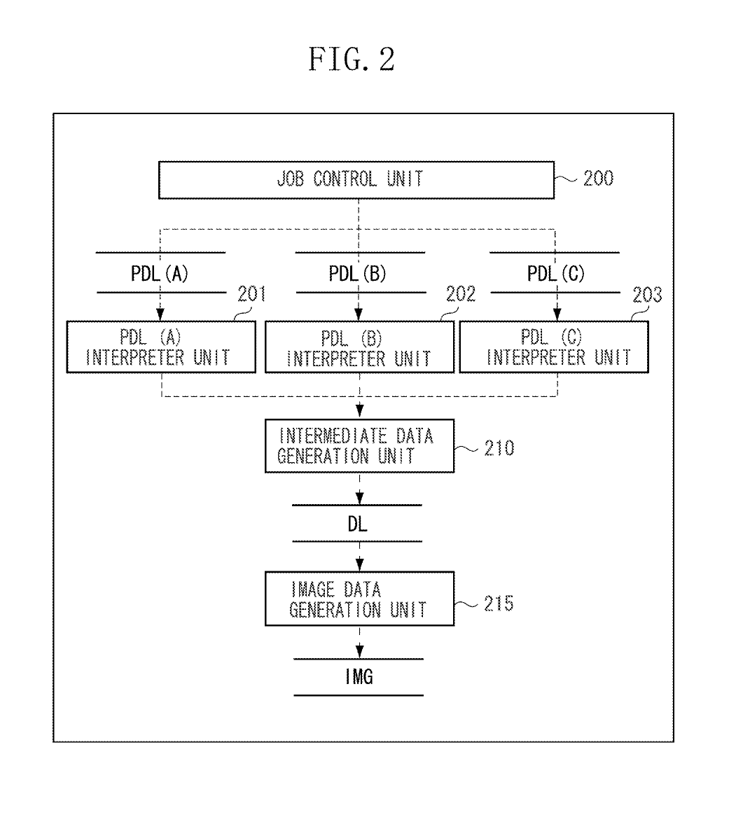

FIG. 2 illustrates an example of a software module that operates in the control device 110 of the image forming apparatus 100 of FIG. 1.

In FIG. 2, a job control unit 200 controls a print job from an input to an output by, for example, using a function call or message communication. Each PDL analysis unit 201, 202, and 203 reads the PDL data stored in a PDL reception buffer and executes an interpretation process under the control of the job control unit 200. The number of PDL interpreter units is equal to the number of types of PDL (e.g., PostScript, PCL, XPS) to be installed in the image forming apparatus 100.

An intermediate data (Display List) generation unit 210 executes a drawing process under the control of the job control unit 200, and based on the drawing information provided from the PDL interpreter units 201, 202, and 203, stores the generated Display List in a frame buffer in the RAM 116. An image data generation unit 215 loads the Display List from the frame buffer, and outputs the image data rendered in the RAM 116 to the printer apparatus 300.

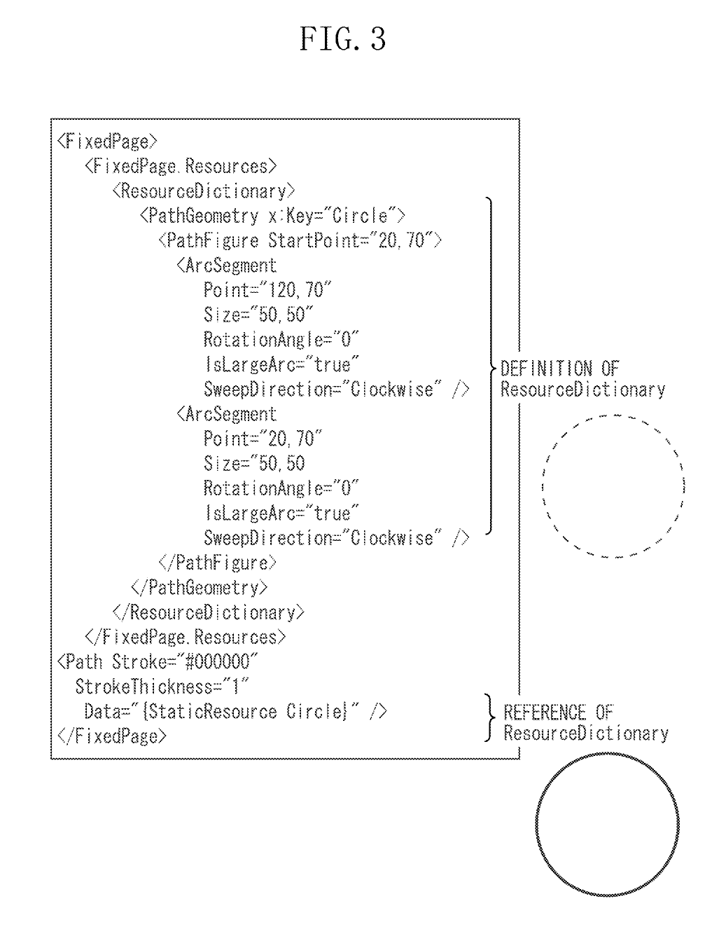

Referring to FIGS. 3 through 6, a description is given of a method for determining a cache format of an RD according to the first exemplary embodiment.

FIG. 3 illustrates an example of a data structure of an XPS document that can be processed by the image processing apparatus according to the present embodiment. In FIG. 3, the RD in the XPS is specified with an effective range as resource information such as FixedPage or Canvas. In the entry example of FIG. 3, a resource is a subordinate to the FixedPage, and the effective range is within the FixedPage. As illustrated in FIG. 3, the RD defines and declares a path of a circle. Then, the RD designates the drawing in a state that drawing information having a stroke width of 1 and a brush color of black is added. The effective range of the resource ends when the FixedPage ends, and the circle path cannot be referred as the language specification any more.

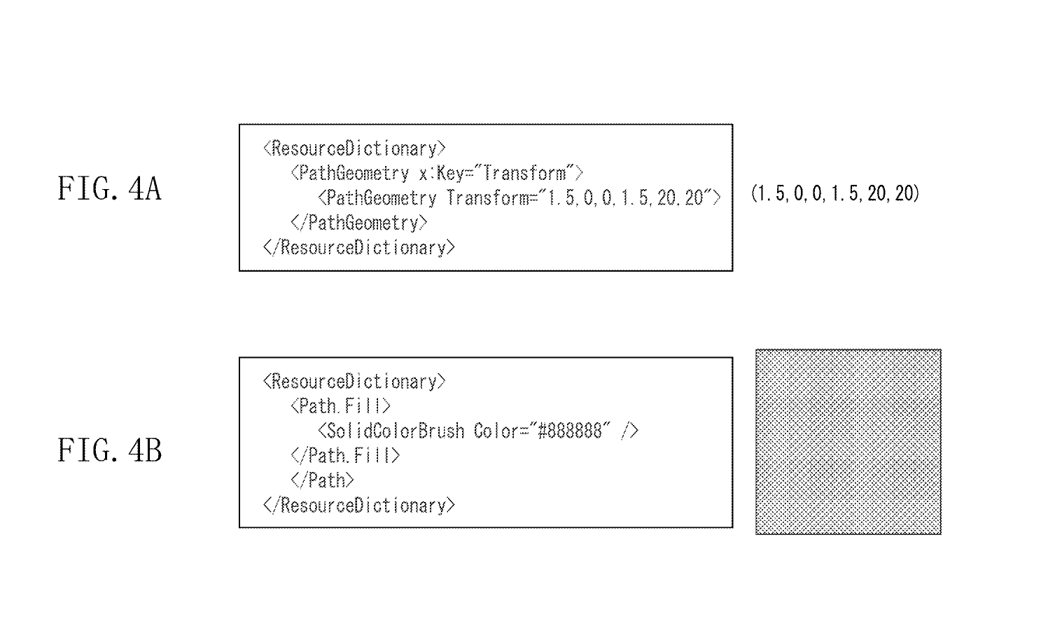

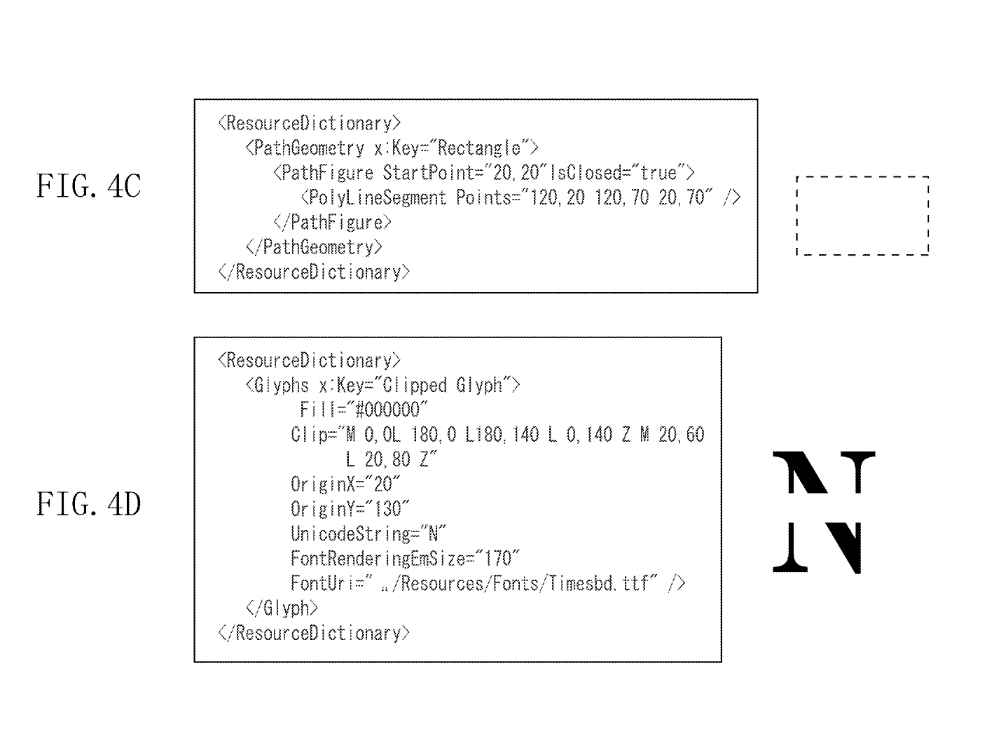

FIGS. 4A through 4D illustrate specific entry examples of an RD in the XPS of FIG. 3.

FIG. 4A illustrates an RD for a coordinate setting. The coordinate setting of 1.5 times enlargement and a parallel movement of 20 in X and Y directions is defined as a reusable resource.

FIG. 4B illustrates an RD for a fill specification. The fill setting of a solid color brush with (R, G, B)=(136, 136, 136) is defined as a reusable resource.

FIG. 4C illustrates an RD for a path specification. The rectangular path linearly connecting four points of (20, 20), (120, 20), (120, 70) and (20, 70) is defined as a reusable resource.

FIG. 4D illustrates an RD of a clipped character. As illustrated in FIG. 4D, a drawing object that is clipped in a rectangular shape with respect to the character “N” is defined as a reusable resource.

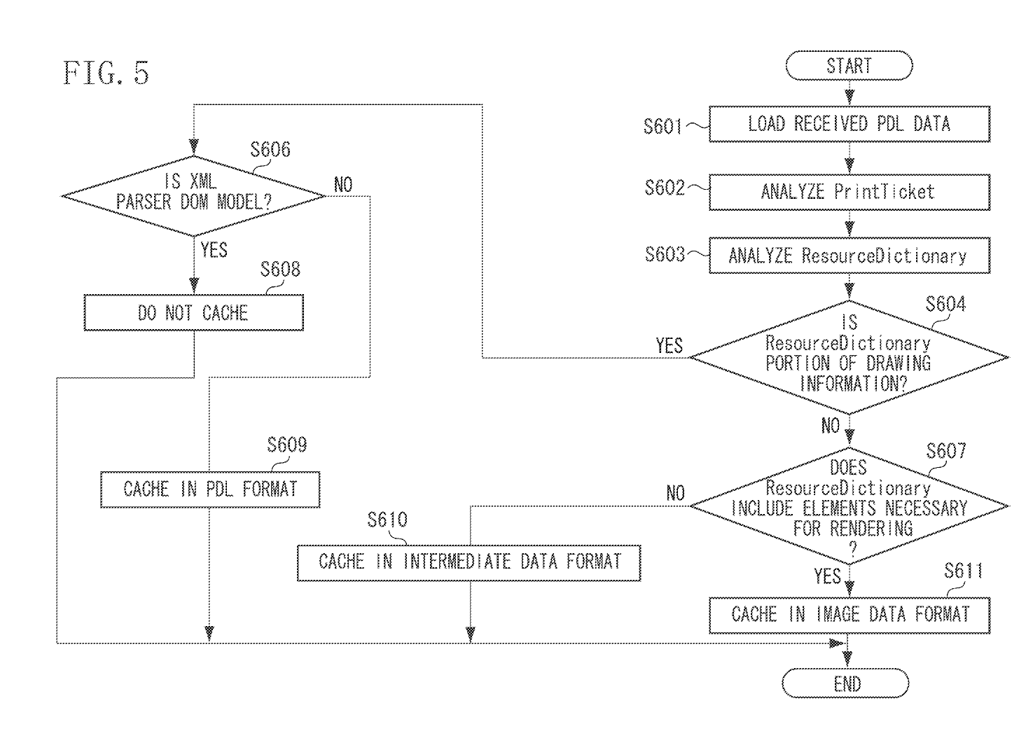

FIG. 5 is a flowchart illustrating a data processing method of the image processing apparatus according to the present embodiment. Specifically, the flowchart describes an example of a cache process including a cache format determination performed when a drawing process is performed with respect to resource information detected from PDL data. Each step in the flowchart is implemented by the CPU 112 of the control device 110 executing a control program (e.g., job control unit, PDL interpreter unit, intermediate data generation unit, image data generation unit) loaded in the RAM 116 from the ROM 114 or another storage device.

The CPU 112 of the image forming apparatus 100 writes PDL data received from the PCs 191 and 192 into the RAM 116. The job control unit 200 receives the PDL data, and then notifies the PDL interpreter units 201, 202, and 203 of a job beginning. Hereinafter, for description purposes, it is assumed that the PDL interpreter unit 201 is notified of the job beginning.

In step S601, the PDL interpreter unit 201 loads the PDL data received from the PC 191 or PC 192. In step S602, the PDL interpreter unit 201 analyzes PrintTicket that is included in the XPS data and describes a print setting. Subsequently, in step S603, the PDL interpreter unit 201 analyzes an RD.

In step S604, the PDL interpreter unit 201 determines whether the RD is a portion of the drawing information. If the RD is a portion of the drawing information (YES in step S604), the operation proceeds to step S606. When the RD is a portion of the drawing information, as in FIG. 4A or FIG. 4B, the RD is not cached or cached in a PDL format since the RD cannot be converted into a drawable level having low abstractness.

In step S606, the PDL interpreter unit 201 determines whether a structural model of an XML parser to be used by an XPS interpreter unit is a document object model (DOM). If the structural model is the DOM (YES in step S606), an object can be randomly accessed. DOM is an API for utilizing from an application an HTML document or XML document recommended by W3C. Level 1 to Level 3 are recommended. XML data can be dealt with as a tree structure in contrast to SAX that is another API for reading XML. However, since it is usually based on the premise that it operates only after reading in all target XML documents, it has drawbacks that a working speed is slow or memory usage is large. Such an object can be directly accessed when a resource is later referred. The operation then advances to step S608 without caching the RD.

On the other hand, if it is determined that the structural model is not the DOM (NO in step S606), the operation proceeds to step S609. For example, when each element is sequentially parsed and converted by a simple API XML (SAX), an RD needs to be cached. While the DOM API was recommended by W3C, the SAX API was developed by XML-DEV mailing-list volunteers. The SAX API has solidified its status as a standard along with the DOM. The SAX API is an event-driven type API which represents an XML document as serial events, differently from the DOM that deals with the XML document as a tree structure. Accordingly, while application software accesses the API in a positive manner in the case of the DOM, the SAX mostly operates in a passive manner in the way that application software waits for arrival of events. Similar to orthodox streaming, it can be designed to give over input data in sequence. Accordingly, memory can be saved, which is suitable to parallel processing. In a case where the XML is read to convert it into a Java object, the SAX is often used. However, for software which needs to carry out random access such as interchanging a head and an end of the XML document, the DOM or an XML database is more suitable.

Application programming interface (API) is an entrance of a function such as library provided by an operating system or a programming language, which can be used from an application. API is mainly provided as a function for file control, window control, image processing, or character control. To be brief, it is an interface configured to enable easier programming to save time in programming an application. Accordingly, in step S609, the PDL interpreter unit 201 caches the RD in a PDL format.

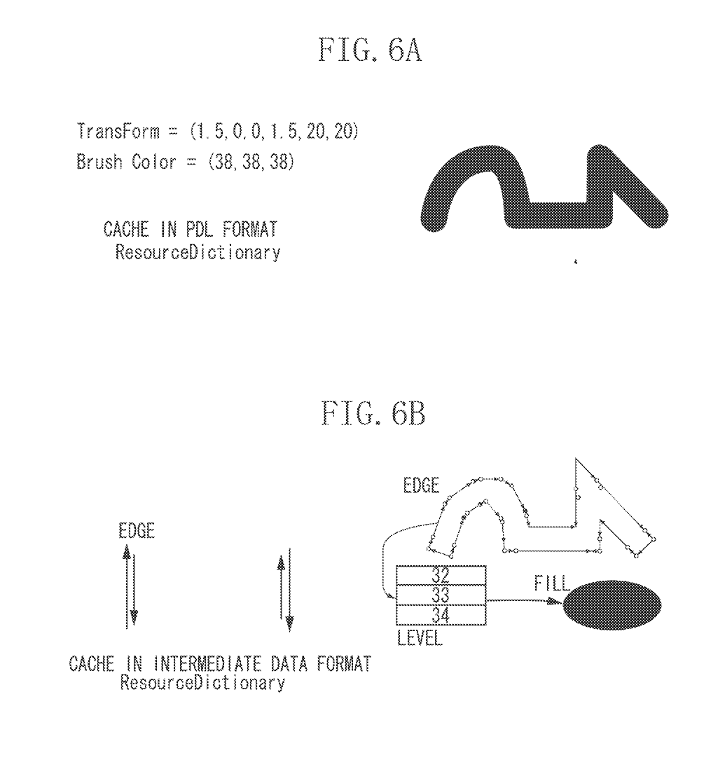

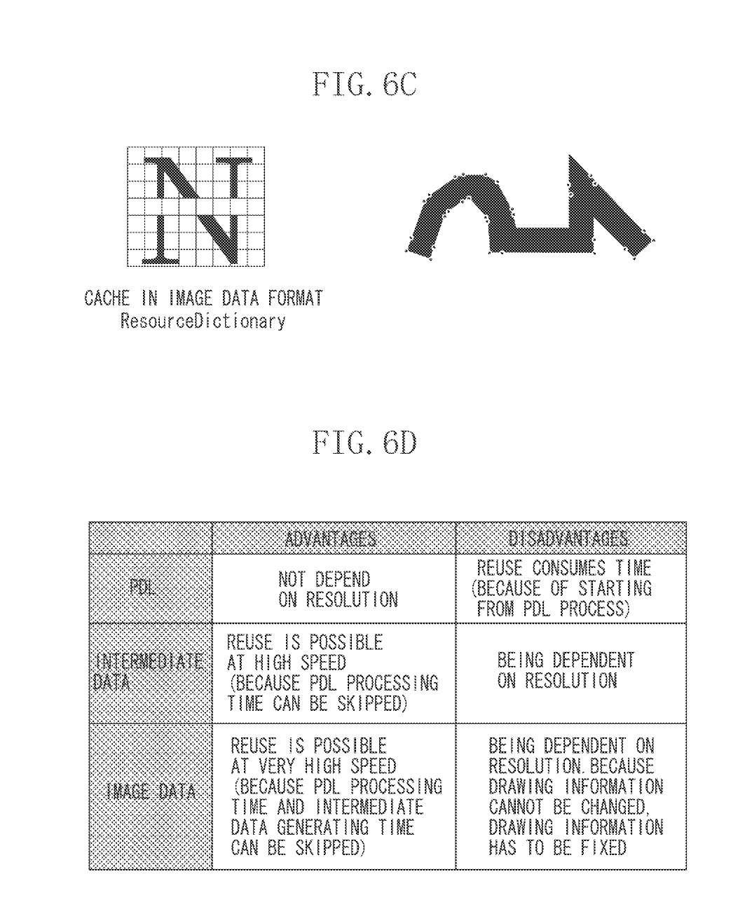

If the PDL interpreter unit 201 determines that the RD is not a portion of the drawing information (NO in step S604), then in step S607, the PDL interpreter unit 201 determines whether the RD includes elements such as edge, level, and fill, which are necessary for rendering. If the RD does not include the elements necessary for rendering (NO in step S607), then in step S610, the PDL interpreter unit 201 caches the RD in the RAM 116. Herein, the RD is cached in an intermediate data format with edge information and level information separated from each other, as illustrated in FIG. 6B.

If the PDL interpreter unit 201 determines that the RE includes the elements necessary for rendering (YES in step S607), then in step S611, the PDL interpreter unit 201 caches the RD in a bit map image format after undergoing the rendering processing, as illustrated in FIG. 6C.

This is done because, when an RD is renderable, the PDL interpreter unit 201 caches the RD in an image data format that has a shorter reproduction time at the time of reuse. When an RD does not have sufficient drawing elements for rendering, the RD is cached in an intermediate data format instead of the image data format. Accordingly, the performance of the cache process can be enhanced.

FIGS. 6A, 6B, 6C and 6D are schematic diagrams illustrating cache formats and characteristics thereof in the image processing apparatus according to the present embodiment. The RDs of FIGS. 4A through 4D are classified into formats of FIGS. 6A through 6C according to the cache format determination described in the flowchart of FIG. 5.

FIG. 6A illustrates an example of an RD to be cached in a PDL format. The coordinate setting of FIG. 4A and the fill specification of FIG. 4B are each only a portion of drawing information, and thus cannot be converted into intermediate data. Consequently, such an RD is cached in a PDL format of a command level. The PDL format is at high level of abstractness and is in a resolution-independent state.

FIG. 6B illustrates an example of an RD to be cached in an intermediate data format. As illustrated in FIG. 6B, intermediate data (DisplayList) includes an edge representing outline information, a level representing height or a combining means, and a fill representing fill information. The edge, level, and fill are linked to one another so that an RD becomes renderable.

A path specification as illustrated in FIG. 4C is drawing information that can be converted into an edge in intermediate data. Such drawing information is cached, being converted into edge information having a coordinate position and orientation information as illustrated in FIG. 6B. When a drawing process is actually performed, the level and the fill information is added and rendered at the time of reference so that image data is formed.

FIG. 6C illustrates an example of an RD to be cached in an image data format. When all the necessary information for rendering is defined in an RD, the RD is cached as image data of the rendering result.

FIG. 6D is a table illustrating characteristics of each of the cache formats. When an RD is cached in a PDL format, the cached RD has an advantage of not being dependent on the resolution. Accordingly, when a print setting is changed at the time of cache reference, re-generation of cache data is not needed. Reuse of the RD cached in the PDL format tends to consume time because it starts from an analysis of PDL.

When an RD is cached in an intermediate format, the RD is converted into an intermediate level while skipping an interpretation process so that the RD can be reused at high speed. On the other hand, the RD cached in the intermediate format is dependent on the resolution. Consequently, when a print setting is changed at the time of cache reference, cache data of the intermediate data needs to be regenerated.

When an RD is cached in an image data format, the RD can be reused at very high speed since a PDL interpretation process can be skipped and intermediate data is already rendered.

The RD cached in the image data format, on the other hand, is dependent on the resolution. Therefore, when a print setting is changed at the time of cache reference, cache data of the intermediate data needs to be regenerated. It is because drawing information such as edge, level, and fill which constitute the intermediate data, depends on resolution and cannot deal with change of print setting.

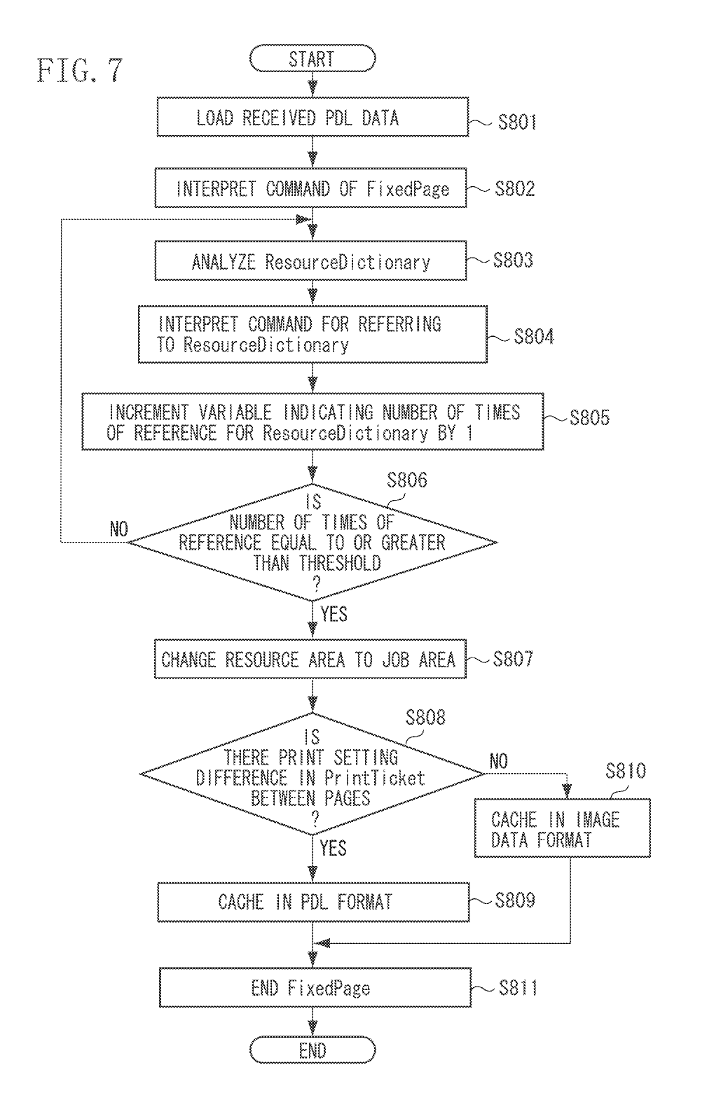

Referring to FIGS. 7 through 9, a description is given of a method for changing a cache area of an RD according to a second exemplary embodiment.

FIG. 7 is a flowchart illustrating a data processing method of an image processing apparatus according to the second exemplary embodiment. Specifically, an example method for changing a cache area is described. Each step in the flowchart is implemented by a CPU 112 of a control device 110 executing a control program (e.g., job control unit, PDL interpreter unit, intermediate data generation unit, image data generation unit) loaded to a RAM 116 from a ROM 114 or another storage device.

The CPU 112 of an image forming apparatus 100 writes PDL data received from PCs 191 and 192 into the RAM 116. A job control unit 200 receives the PDL data, and then notifies any of PDL interpreter units 201, 202, and 203 of the beginning of a job.

In step S801, each of the PDL interpreter units 201, 202, and 203 loads the received PDL data. In step S802, each of the PDL interpreter units 201, 202, and 203 interprets XPS data to interpret a command of FixedPage serving as a start page. Subsequently, in step S803, each of the PDL interpreter units 201, 202, and 203 analyzes an RD. Hereinafter, for description purposes, it is assumed that the PDL interpreter unit 201 is notified of the beginning of the job.

Instep S804, the PDL interpreter unit 201 interprets a command for referring to the RD generated in step S803. In step S805, the PDL interpreter unit 201 increments a variable indicating the number of times of referencing the RD by one.

In step S806, the PDL interpreter unit 201 determines whether the incremented number of times of reference is equal to or greater than a threshold. If the incremented number of times of reference is not equal to or greater than the threshold (NO in step S806), the RD is determined not to be cached since the number of reuse times is relatively small. Accordingly, the operation returns to step S803, and the PDL interpreter unit 201 continues to analyze the XPS data instead of proceeding to a cache generation process.

If the incremented number of times of reference is equal to or greater than the threshold (YES in step S806), then instep S807, the PDL interpreter unit 201 changes an effective range of the resource (resource area) from the FixedPage to a job area that is to be effective across pages.

Subsequently, in step S808, the PDL interpreter unit 201 determines whether there is any print setting difference in PrintTicket between pages. If a print setting differs in PrintTicket (e.g., output resolution, color conversion method) between pages (YES in step S808), then in step S809, the PDL interpreter unit 201 caches the drawing information in a PDL format in the RAM 116, which is not dependent on the print setting.

If there is no print setting difference in PrintTicket (e.g., output resolution, color conversion method) between pages (NO in step S808), then in step S810, the PDL interpreter unit 201 caches the drawing information in an image data format in the RAM 116, which is a data format for print setting. Subsequently, in step S811, the PDL interpreter unit 201 ends the process on the FixedPage, and then repeats a series of processes on each page.

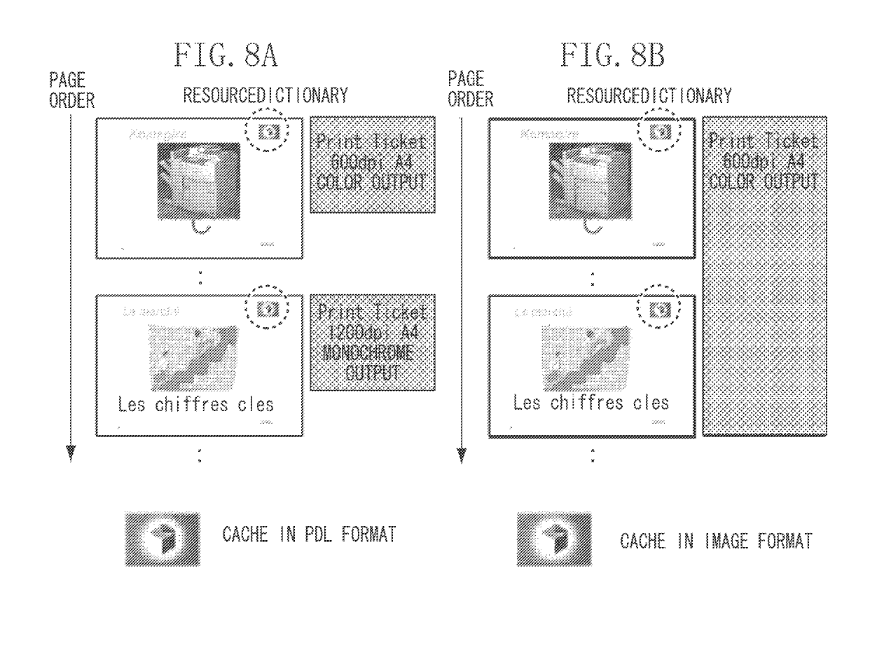

FIGS. 8A and 8B are schematic diagrams illustrating a change in a cache area in the image processing apparatus according to the present embodiment. In the example diagrams of FIGS. 8A and 8B, an RD is not defined with a scope that exceeds FixedPage according to the XPS specifications. There are cases where an actual printed product has the same resource for every page. In such a case, an identical resource is generated and deleted with respect to each page. When the same resource is referred within a job for more than the predetermined number of times, the PDL interpreter unit 201 increases an effective range from the FixedPage to a job area and caches the RD.

When each page has a different print setting in PrintTicket, the PDL interpreter unit 201 caches drawing information at a PDL level, which is not dependent on the print setting, in the RAM 116 as illustrated in FIG. 8A. When there is no exceptional setting, the PDL interpreter unit 201 caches drawing information at an intermediate level, which is dependent on the print setting, in the RAM 116 as illustrated in FIG. 8B.

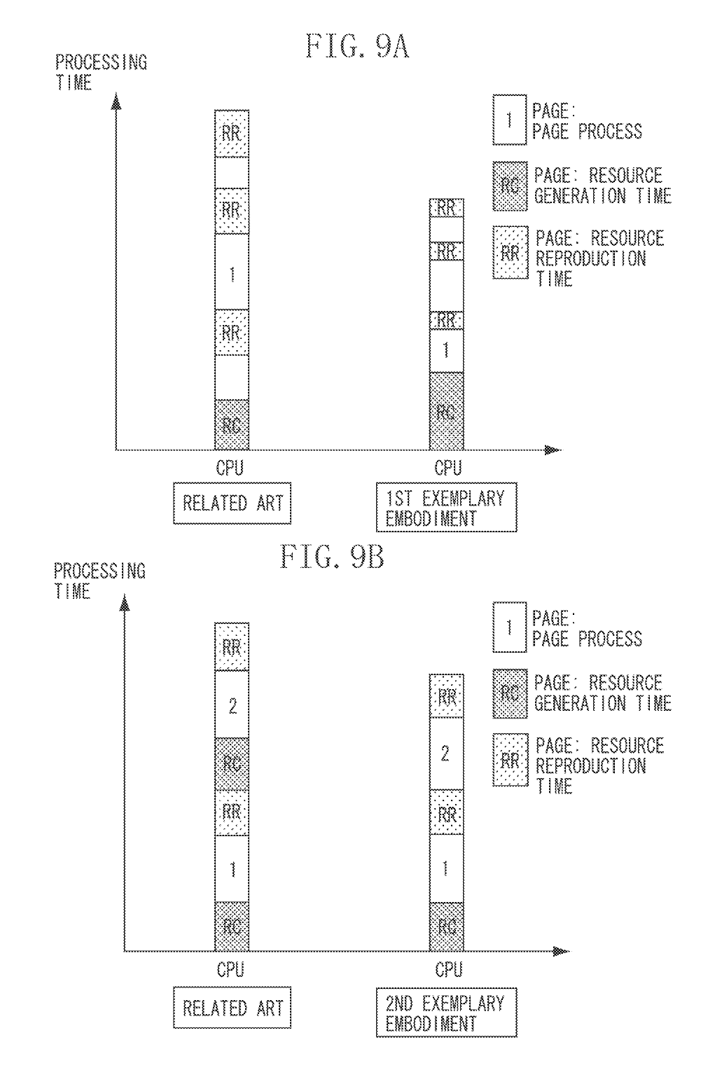

FIGS. 9A and 9B are diagrams illustrating examples of performance efficiency of the image processing apparatus according to the first and second exemplary embodiments. In FIGS. 9A and 9B, the performance efficiency is compared to that of a conventional method.

FIG. 9A illustrates a schematic diagram illustrating a processing time when a test job is performed by using a determination unit for determining a cache format of resource data corresponding to a characteristic of the RD according to the first exemplary embodiment. For example, a method caches an RD in a PDL format as illustrated in FIG. 4D. According to such a method, an initial resource generation time (RC) is relatively short, whereas a resource reproduction time (RR) involves a time cost because it includes an intermediate data generation time and a rendering time.

According to the exemplary embodiments of the present invention where an RD is cached in an image data format as illustrated in FIG. 4D, an initial resource generation time (RC) involves a time cost which includes an intermediate data generation time and a rendering time. However, a resource reproduction time (RR) is shortened, so that printing performance is enhanced, as illustrated in FIG. 9A.

FIG. 9B is a schematic diagram illustrating a processing time when a cache effective area of an RD, which is referred the greater number of times, is increased so that the cache area is referred across pages instead of FixedPage according to the second exemplary embodiment.

For example, a method repeatedly generates and releases resources within FixedPage. Consequently, an RD is repeatedly generated and deleted within a page in print data, as illustrated in FIG. 8B, causing a time cost in each generation and deletion. According to the second exemplary embodiment in which a cache effective area of an RD having the greater number of times for reference is expanded from the FixedPage to an area across pages, a resource generation time (RC) is omitted from a second page and thereafter, as illustrated in FIG. 9B. Accordingly, print performance is enhanced according to the second exemplary embodiment.

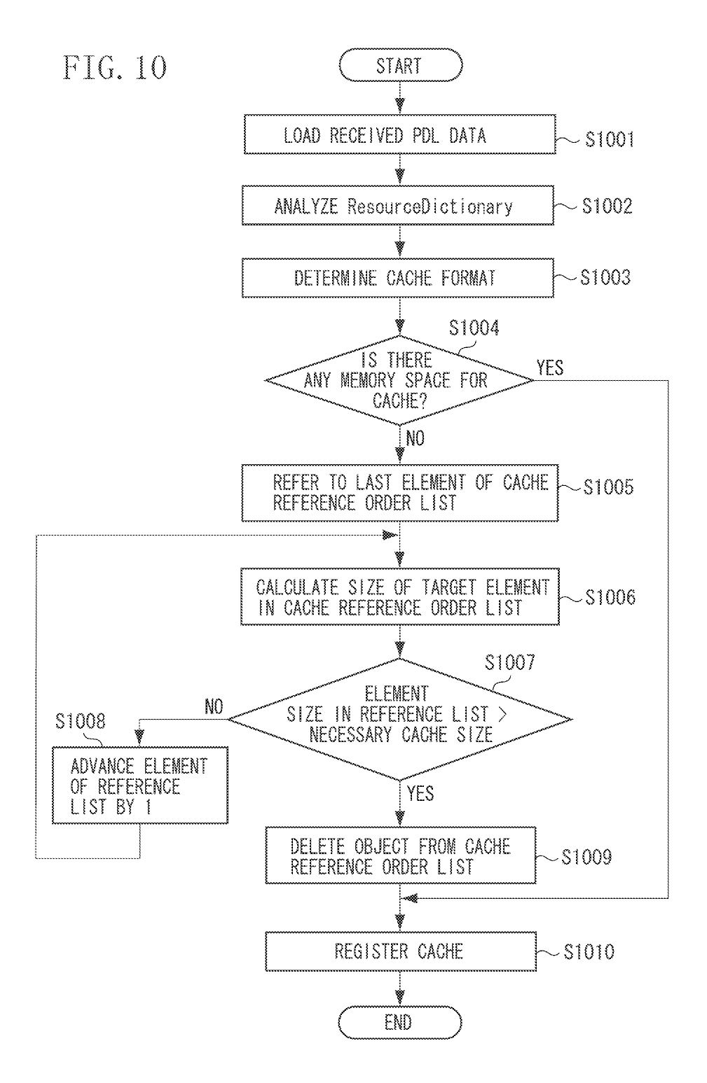

FIG. 10 is a flowchart illustrating a data processing method of an image processing apparatus according to a third exemplary embodiment. Specifically, the flowchart describes a method for deleting a cache area. Each step in the flowchart is implemented by a CPU 112 of a control device 110 executing a control program (e.g., job control unit, PDL interpreter unit, intermediate data generation unit, image data generation unit) loaded to a RAM 116 from a ROM 114 or the other storage device.

The CPU 112 of an image forming apparatus 100 writes PDL data received from PCs 191 and 192 into the RAM 116. A job control unit 200 receives the PDL data, and then notifies each of PDL interpreter units 201, 202, and 203 of the beginning of a job. Hereinafter, for description purposes, it is assumed that the PDL interpreter unit 201 is notified of the beginning of a job.

In step S1001, the PDL interpreter unit 201 loads the PDL data received by the job control unit 200. In step S1002, the PDL interpreter unit 201 interprets XPS data to analyze a command of the RD. Subsequently, in step S1003, the PDL interpreter unit 201 determines a cache format by following the flow described with reference to FIG. 5.

In step S1004, the PDL interpreter unit 201 determines whether there is any memory space in the RAM 116 for cache registration. If the RAM 116 has a memory space for a cache (YES in step S1004), then in step S1010, the PDL interpreter unit 201 registers the cache in the determined cache format. On the other hand, if there is no space in the RAM 116 (NO in step S1004), then in step S1005, the PDL interpreter unit 201 refers to the last element of a cache reference order list.

In step S1006, the PDL interpreter unit 201 calculates a size of a target element in the cache reference order list. Subsequently, in step S1007, the PDL interpreter unit 201 determines whether an element size in the reference list is larger than necessary cache size. If the element size is smaller than the necessary cache size (NO instep S1007), cache capacity is insufficient, and thus a next element needs to be searched. Instep S1008, the PDL interpreter unit 201 advances an element of the reference list by one to search for a next element in the list, and then repeats the operation to return to step S1006. On the other hand, if the element size is larger than the necessary cache size (YES in step S1007), there is sufficient cache capacity, and the operation proceeds to step S1009. In step S1009, the PDL interpreter unit 201 deletes an object from the cache reference order list. Subsequently, in step S1010, the PDL interpreter unit 201 registers the cache, and a series of processes ends.

The present invention has been described above with respect to particular exemplary embodiments, but is not limited thereto. It should be understood that the present invention encompasses all the possible modifications (including combinations of each of exemplary embodiments) which are not to be excluded from scope of the present invention.

According to the exemplary embodiment of the present invention, a cache process can be changed corresponding to a characteristic of resource information when PDL data is interpreted and then drawing information specified by resource information is cached.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-047849 filed Mar. 4, 2011, which is hereby incorporated by reference herein in its entirety.

What is claimed is:

1. An image processing apparatus capable of performing a drawing process with respect to resource information detected from predetermined PDL data, the image processing apparatus comprising:
a memory; and
a control device, connected to the memory, the control device configured to control:
at least one interpretation unit configured to interpret the resource information; and
a control unit configured to change a cache process with respect to the resource information corresponding to a characteristic of the resource information interpreted by the at least one interpretation unit.

2. The image processing apparatus according to claim 1, wherein the control unit changes a cache format of cache data with respect to the resource information corresponding to a characteristic of the resource information interpreted by the at least one interpretation unit.

3. The image processing apparatus according to claim 2, wherein the cache format of the cache data includes a PDL format, an intermediate data format, and an image format.

4. The image processing apparatus according to claim 1, wherein the control unit changes a cache area of cache data with respect to the resource information corresponding to a characteristic of the resource information interpreted by the at least one interpretation unit.

5. The image processing apparatus according to claim 1, wherein when the at least one interpretation unit includes a parser for analyzing resource information, the control unit changes a cache format corresponding to a structural model of the parser.

6. The image processing apparatus according to claim 1, wherein the predetermined PDL data is XPS data.

7. An image processing method for performing a drawing process with respect to resource information detected from predetermined PDL data, the image processing method comprising:
interpreting the resource information; and
performing control to change a cache process with respect to the resource information corresponding to a characteristic of the interpreted resource information.

8. A computer-readable storage medium configured to store a program for causing a computer to execute the method of claim 7.

9. An image processing apparatus comprising:
a memory; and
a control unit, connected to the memory, the control unit configured to control:
a determination unit configured to determine whether a number of times of referencing a resource exceeds a threshold;
a changing unit configured to change a resource area to be effective across pages when the number of times of referencing the resource exceeds the threshold; and
a cache unit configured to cache in a PDL format when a print setting differs across pages and to cache in an image format when a print setting does not differ across the pages.
